(19) United States
(12) Patent Application Publication
(10) Pub. No.: US 2011/0090612 A1
(43) Pub. Date: Apr. 21, 2011

(54) ATMOSPHERE CLEANING DEVICE

(75) Inventors: Junji Oikawa, Yamanashi (JP); Akitake Tamura, Yamanashi (JP); Teruyuki Hayashi, Miyagi (JP)

(73) Assignee: TOKYO ELECTRON LIMITED, Tokyo (JP)

(21) Appl. No.: 12/937,528

(22) PCT Filed: Apr. 13, 2009
(86) PCT No.: PCT/JP2009/057459

§ 371 Date: Jan. 4, 2011

(30) Foreign Application Priority Data
Apr. 14, 2008 (JP) 2008-105187

(51) Int. Cl. H05F 3/00

(52) U.S. Cl. 361/226

(57) ABSTRACT

Provided is an atmosphere cleaning device comprising a means for establishing a down-flow in the atmosphere, in which a treating object is positioned, a plurality of ionizers arranged at positions above the treating object and symmetrically in the layout, as viewed downward, across the treating object, for feeding either cation or anion transversely of the down-flow, and a means for applying such a DC voltage to the treating object as has the same polarity as that of the voltage being applied to those ionizers. The atmosphere cleaning device is characterized in that the symmetrically arranged ionizers are arranged to face each other.

### TECHNICAL FIELD

The present invention relates to an atmosphere cleaning device for use in a semiconductor fabrication line.

### BACKGROUND

In general, a clean room in a semiconductor fabrication line has a ceiling on which a fan filter unit (FFU) is installed to supply air, and an air intake fan is installed on the bottom to suck air thereby forming a descending current (so called a down-flow) in the atmosphere where substrates such as semiconductor wafers or glass substrates are disposed. In addition, such formation of the down-flow is employed for the air transfer atmosphere in a semiconductor fabrication apparatus.

In the above-described method, the cleaned air from the FFU is supplied to the atmosphere where substrates are arranged. Particles generated in the atmosphere caused by, for example, a substrate transfer are forcedly moved to the lower portion of the atmosphere by the gravity and inertial force based on the down-flow, and discharged to the outside from the atmosphere, thereby maintaining the atmosphere at a clean state. Among the atmosphere in which substrates are disposed, a measure for preventing the contamination by the particles is important particularly in the atmospheric transfer process (that is, atmosphere above the transfer path), as dusts are easily generated from a driving unit of a substrate transfer mechanism, and thin films are easily taken off from the circumferential edge of the substrate during the substrate transfer to generate particles.

However, as the wiring pattern of a substrate is becoming denser, the management on the contamination caused by the particles is also becoming stricter. That is, as the pattern is becoming miniaturized, particles having diameters which have been allowed thus far become problems nowadays. This means that the diameter of the particles to be prevented from being adhered on substrates are becoming smaller. Regarding the particles having smaller diameters, conventional methods have drawbacks as follows. When the diameter of the particles is reduced, the influence of the inertial force to the particles caused by the gravity or the down-flow is reduced. Due to this, conventional methods for controlling the air flow using FFUs increase the influence of a diffusion, which makes it difficult to control the tiny particles, and to move the particles to the area below substrates. As a result, the particles may be adhered to the substrates.

Regarding the above problems, it is known that an ion generator is installed to in a transfer device, and the particles in the transfer device are charged. Then, the DC voltage having the same polarity as that of the charged particles is applied to a semiconductor substrate so as to prevent the particles from being adhered on the substrate by the electrostatic repulsive force between the particles and the substrate having the same polarity [Japanese Patent Laid-open Publication No. 2005-116823, paragraphs 0043, 0044]. The above-mentioned atmosphere transfer device allows the particles to spatter from the substrate by the electrostatic repulsive force. Therefore, the particles can be prevented from being adhered with an improved precision as compared to the air flow control by the FFU. However, this prior art apparatus considers nothing of the electric field caused by the ion generator, and therefore, it is insufficient for a method that prevents the adhesion of particles having tinier sizes.

### SUMMARY OF THE INVENTION

In view of the foregoing problems, the present invention has an object to provide an atmosphere cleaning device which can prevent particles from being adhered onto a treating object.

The present invention is directed to an atmosphere cleaning device characterized by comprising means for forming a down-flow in an atmosphere where a treating object is located, a plurality of ionizers arranged over the treating object symmetrically with each other leaving the treating object therebetween in a layout viewed from above, so as to supply either cation or anion to the down-flow with a transverse direction, and means for applying DC voltage having the same polarity as that of the voltage applied to the electrodes of the plurality of ionizers to the treating object, wherein the symmetrically arranged ionizers face each other.

According to the present invention, particles are prevented from being adhered onto a treating object by the electrostatic repulsive force generated between the particles charged by the ionizers and the treating object where the voltage is applied. Here, based on the knowledge (such as data obtained from experiments) of the present inventor such as the relative relationship between the ionizer and the treating object as a big influential factor to the preventing effect of the particles to the treating object and further, the fact that the amount of adhered particles are changed depending on the voltage of the treating object, the electrostatic distribution near the surface of the treating object based on an ionizer is becoming uniform by the electrostatic distribution based on another ionizer by placing the plurality of ionizers symmetrically between the treating object, and the variation in the surface is reduced with respect to the influence of the electrostatic distribution by the electrostatic of the ionizer near the surface of the treating object. As a result, an appropriate electrostatic repulsive force can be applied over the particles to the entire surface of the treating object. Due to this, the adhesion of even fine particles to the treating object can be effectively reduced.

For example, above-mentioned plural pairs of ionizers which are symmetrically arranged can be arranged along the periphery of the treating object. Alternatively, a plurality of ionizers are arranged into groups along the periphery of the treating object, and the groups may be arranged symmetrically with each other with the treating object interposed therebetween in a layout viewed from the top. In this case, the groups are preferably formed by arranging the plurality of ionizers in a single row along with a transverse direction.

Also, for example, when a band type transfer path is installed to transfer the treating object, a plurality of ionizers can be arranged into a row along both sides of the transfer path in a plane view layout.

Alternatively, the present invention is an atmosphere cleaning device to characterized by comprising means for forming a down-flow in an atmosphere where a treating object is located, a plurality of ionizers spaced apart from each other in a transverse direction above the treating object, so as to supply either cation or anion downwardly to the down-flow, and means for applying DC voltage to the treating object having the same polarity as that of the voltage applied to the electrodes of the plurality of ionizers.

In accordance with the present invention, as the plurality of ionizers for supplying ions downwardly from above the treating object are spaced apart from each other in a transverse direction, the fluctuation of the surface electric potential of the treating object occurs less, and thus suppressing the tiny particles from being adhered to the treating object.

For example, the atmosphere in which the treating object is located is an atmosphere where the treating object is transferred by a transfer device, and the plurality of ionizers are arranged along the transfer direction of the treating object. In this case, it is desirable to dispose the plurality of ionizers directly above the transfer path for transferring the treating object.

Alternatively, for example, the atmosphere in which the treating object is located is an atmosphere where the treating object is transferred by a transfer device, and the plurality of ionizers are arranged at the position corresponding to the tops of tetragons in a layout viewed from the top, when the region is divided into a plurality of tetragons with the same size.

Alternatively, for example, the atmosphere in which the treating object is located is an atmosphere where the treating object is transferred by a transfer device, and the plurality of ionizers are arranged into a zigzag shape in a layout viewed from the top.

The layout of the plurality of ionizers is a layout in which a row of ionizers are arranged in any one of the X-direction and the Y-direction orthogonal to each other on a horizontal plane, or three or more rows of ionizers are arranged.

Alternatively, the present invention is an atmosphere cleaning device characterized by comprising means for forming a down-flow in an atmosphere where a treating object is transferred by a transfer device, a plurality of ionizers arranged above an object transfer region in a layout viewed from the top, so as to supply either cation or anion to the down-flow, means for applying DC voltage to the treating object having the same polarity as that of the voltage applied to electrodes of the plurality of ionizers, and means for controlling the size of the voltage applied to the electrodes of the ionizers in accordance with the location of the treating object.

The present invention is advantageous in that a plurality of ionizers are arranged above an object transfer region, and the size of the voltage applied to the electrodes of the ionizers is controlled in accordance with the location of the treating object, to thereby reduce the fluctuation of the surface electric potential of the treating object, and thus enabling inside of the surface of the treating object to uniformly suppress the particles from being adhered to the treating object.

### BRIEF DESCRIPTION OF THE DRAWINGS

FIG. 1 is an explanatory view illustrating the principle of the present invention.

FIG. 2 is a view illustrating the configuration of a first experimental device regarding the principle of the present invention.

FIG. 3 is a characteristic diagram illustrating the result of experiment 1 regarding the principle of the present invention.

FIG. 4 is an explanatory view illustrating the result of experiment 1 regarding the principle of the present invention.

FIG. 5A and FIG. 5B are explanatory views illustrating the result of experiment 1 regarding the principle of the present invention.

FIG. 6A is a view illustrating the configuration of a second experimental device regarding the principle of the present invention.

FIG. 6B is a view illustrating the arrangement of ionizers in the device shown in FIG. 6A.

FIG. 7 is a characteristic diagram illustrating the result of experiment 2 regarding the principle of the present invention.

FIG. 8a is a plane view illustrating an atmosphere cleaning device according to a first exemplary embodiment of the present invention.

FIG. 8b is a side view illustrating the atmosphere cleaning device according to the first exemplary embodiment of the present invention.

FIG. 9 is a plane view illustrating a modified example of the first exemplary embodiment of the present invention.

FIG. 10 is a plane view illustrating an atmosphere cleaning device according to a second exemplary embodiment of the present invention.

FIG. 11A is a plane view illustrating a modified example of the second exemplary embodiment of the present invention.

FIG. 11B is a side view illustrating a modified example of the second exemplary embodiment of the present invention.

FIG. 12 is a perspective view illustrating a semiconductor fabrication device comprising the modified example of the second exemplary embodiment of the present invention.

FIG. 13 is a schematic plane view illustrating the semiconductor fabrication device comprising the modified example of the second exemplary embodiment of the present invention.

FIG. 14 is a schematic vertical cross sectional view illustrating the semiconductor fabrication device comprising the modified example of the second exemplary embodiment of the present invention.

FIG. 15 is a partial plane view illustrating the semiconductor fabrication device comprising the modified example of the second exemplary embodiment of the present invention.

FIG. 16 is a plane view illustrating a liquid process system according to a third exemplary embodiment of the present invention.

FIG. 17 is an explanatory view illustrating a wafer (W) standby state in the liquid process system shown in FIG. 16.

FIG. 18 is a plane view illustrating a modified example of the liquid process system shown in FIG. 16.

### DETAILED DESCRIPTION

Knowledge obtained by the inventor of the present invention.

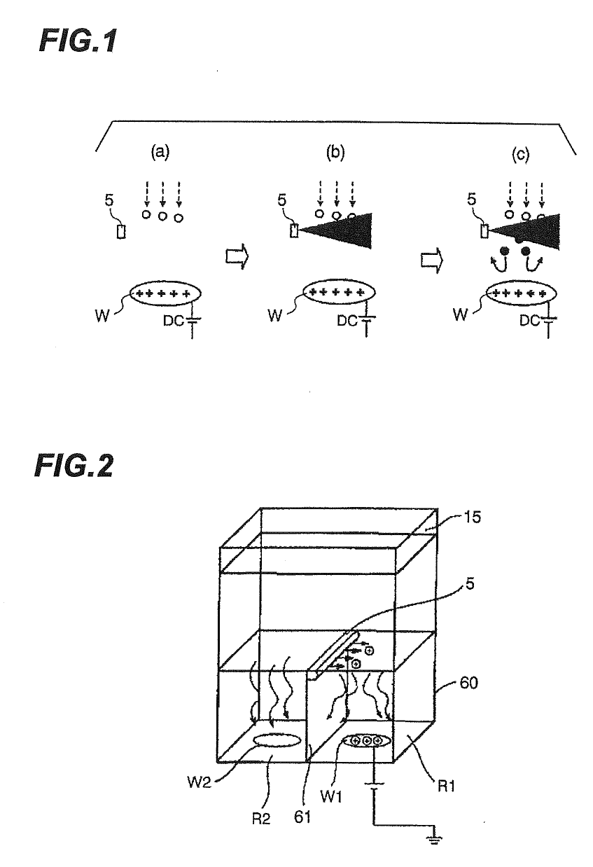

Before explanation on detailed exemplary embodiments of the present invention, knowledge obtained by the inventor of the present invention will be described. In a semiconductor fabrication line, a down-flow is formed in the atmosphere in which semiconductor wafers as a treating object (hereinafter, referred to as a “wafer W”) is disposed. The down-flow is formed by the FFU and an exhaust fan arranged respectively in an upper portion and a lower portion of the atmosphere in which the wafer W is disposed. As shown in FIG. 1, the present invention includes ionizers 5 arranged above the wafer W to supply either cation or anion (FIG. 1a). The ionizers 5 supply ionized gas to the down-flow to charge particles flowing along the down-flow (FIG. 1b). Along with this, a voltage having the same polarity as that of the voltage applied to the electrodes of ionizers 5 is applied to the wafer W, thereby producing electrostatic repulsive force between the particles and the wafer W (FIG. 1c). Further details of ionizers 5 will be described later.

The inventor of the present invention has conducted a first experiment in which four ionizers 5 are arranged into a transverse row, as shown in FIG. 2. In the first experiment, a box 60 has an interior in which a down-flow is formed by an FFU 15 and an exhaust fan (not shown), and is divided into two regions by a partition 61. Ionizers 5 are arranged in one region R1 to apply a positive charge in a transverse direction. In the meantime, no ionizer is arranged in the other region R2. Wafers W1 and W2 disposed in the respective regions R1 and R2 are exposed to the down-flow for a predetermined of time. The value of the applied voltage to wafer W1 which is positive voltage is continuously changed while wafer W2 is grounded. Then, the particles on wafers W1 and W2 disposed in the respective regions R1 and R2 are checked.

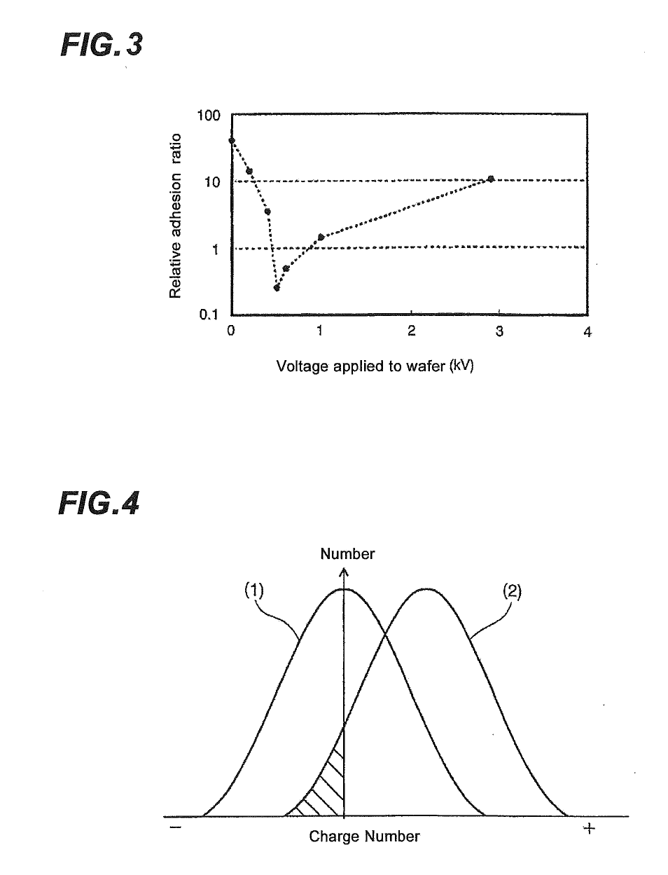

The result of the first experiment is shown in FIG. 3 in which a relative adhesion ratio of the particles in regions R1 and R2 is obtained by dividing “a” by “b”, where “a” is the number of particles adhered to wafer W1 in region R1, and “b” is the number of particles adhered to wafer W2 in region R2. When the voltage applied to wafer W1 gradually rises from 0V to 500V, the relative adhesion ratio is gradually lowered and becomes approximately 0.25 at the point near 500V. As seen here, in a case where voltage of 500V is applied to wafer W1, approximately 75% of particles are prevented from being adhered to wafer W1 as compared to wafer W2. When the voltage applied to wafer W1 is raised higher than 500V, the relative adhesion ratio rises on the contrary.

It has been assumed that the above-described result of the first experiment comes from the following factors. FIG. 4 is a graph in which a vertical axis represents the number of particles, and a horizontal axis represents the charge numbers. When no ionizer is installed, the distribution of the positive electric charges and the distribution of the negative electric charges are generally symmetric, as shown in solid line 1 in FIG. 4. In contrast, when the positive electric charges are applied to the particles by ionizers 5, the distribution of positive electric charges and the distribution of negative electric charges are remarkably positive-sided, as shown in solid line 2 in FIG. 4. From this, it is believed that the amount of the particles which repel by the electrostatic repulsive force increases, thus reducing the amount of particles adhered to wafer W1.

Although the particles are positively charged by ionizers 5, negative-charged particles actually remain, as shown in solid line 2. The negative-charged particles are attracted to the positive potentials. For this reason, it is believed that the positive voltage applied to wafer W1 promotes the adhesion of the negative-charged particles. Actually, from the result of the first experiment, it is determined that the rise of the positive voltage applied to wafer W1 to a predetermined level (that is, 500V in experiment 1) is useful in reducing the amount of adhered particles. However, the rise of the positive voltage exceeding the predetermined level strengthens the force for attracting the negative-charged particles, and thus inhibits the reduction of the amount of adhered particles.

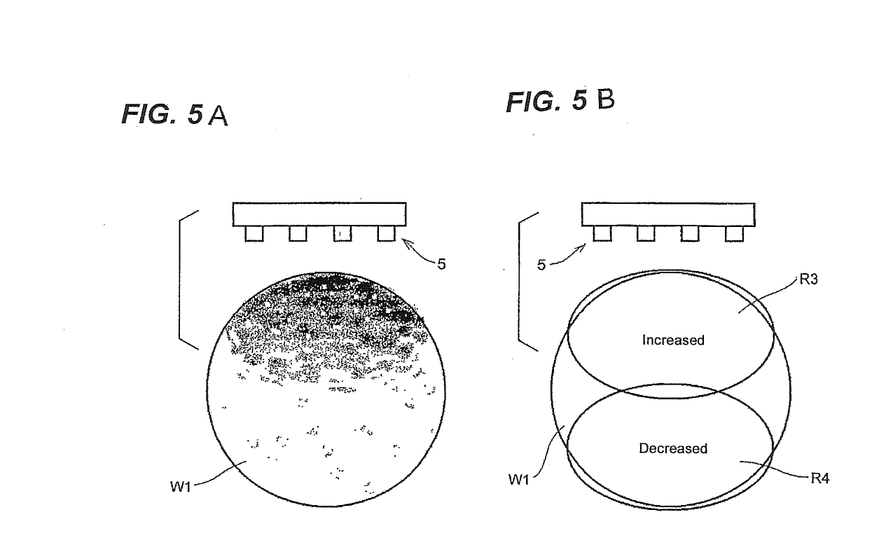

Next, FIG. 5A shows the distribution of the particles on wafer W1. The region on wafer W1 can be roughly divided into regions depending on the number of particles such that region R3 with more amount of adhered particles and region R4 with less amount of adhered particles, as shown in FIG. 5B. It has been assumed that such distribution of the particles is caused by the following factors.

That is to say, an electric line of force is formed from the high voltage applied to the electrode needles of ionizers 5 generating an electric potential distribution in the vicinity of the surface of wafer W1. As region R3 is closer to ionizers 5 than region R4, the electric potential thereof becomes higher than that of region R4. Accordingly, the force of gravity acts by the electric potential to permit particles to be directed toward wafer W1. Referring to FIG. 5, when wafer W1 is viewed from a particle side, electric potential of wafer W1 relatively looks like negative electric potential in region R3. As a result, the particles are attracted closer to region R3 generating a result as shown in FIG. 5A.

Here, when the voltage to be supplied to ionizers 5 is set to lower the electric potential in region R3, which is based on the electric line of force formed from ionizers 5, then, the electric potential based on the electric line of force formed from ionizers 5 is lowered in region R4 which is far from ionizers 5, and the electric potential of wafer W1 looks larger than the optimum value shown in FIG. 3 when wafer W1 is viewed from the particle side. And thus, the negative charged particles are more effectively attracted to region R4.

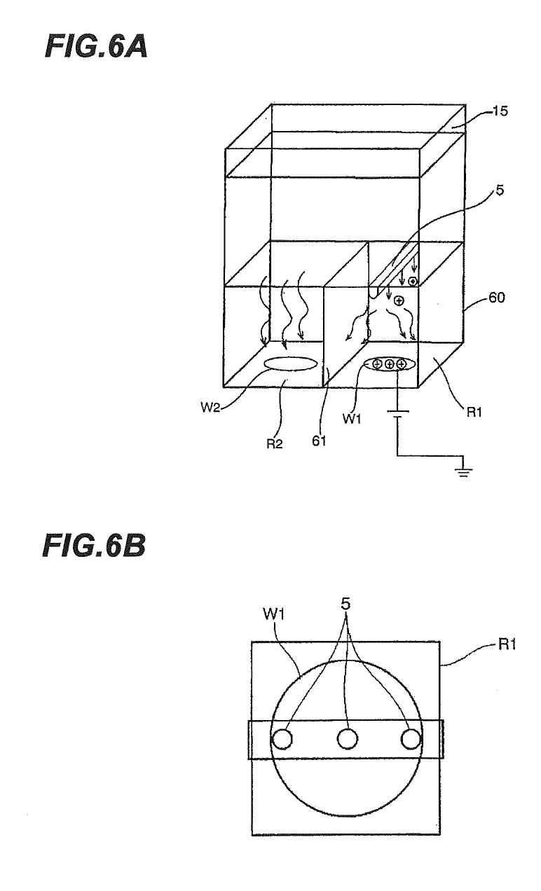

Subsequently, as shown in FIG. 6A and FIG. 6B, the inventor of the present invention has conducted a second experiment in which three ionizers 5 used in the first experiment (shown in FIG. 2) are arranged into a transverse row at a region of vertically above wafer W1.

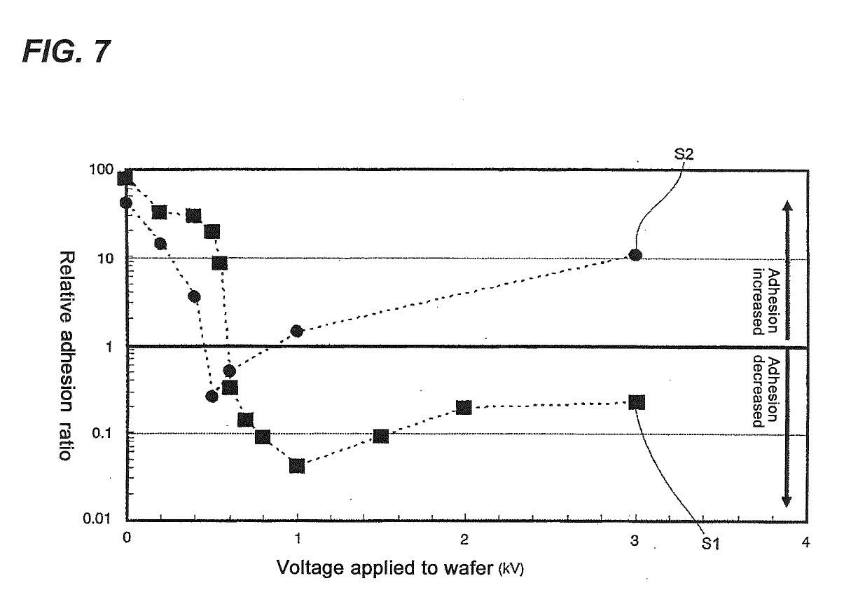

In the second experiment, ionizers 5 are arranged into a row on the line which passes through the center of wafer W1 from vertically above wafer W1 of region R1 (directly above the diameter of wafer W1). Such configuration permits ionizers 5 to apply the positive electric charge to wafer W1 disposed directly below ionizers 5. Except this, the second experiment is conducted in the same fashion as that of the first experiment shown in FIG. 2. The result of the second experiment is illustrated in FIG. 7.

As shown in curved line S1 in FIG. 7, when the voltage applied to wafer W1 gradually rises from 0 V to 1 kV, then the relative adhesion ratio of particles adhered to wafer W1 is lowered and becomes approximately 0.04 at the point near 1 kV. Accordingly, in a case where voltage of 1 kV is applied to wafer W1, approximately 96% of particles are prevented from being adhered to wafer W1 as compared to wafer W2 in the down-flow with no ionizer. Also, when the voltage applied to wafer W1 is raised higher than 1 kV, the relative adhesion ratio rises similarly to the aforementioned first experiment. However, as the relative adhesion ratio cannot be higher than 1.0, a preventive effect against the adhesion of particles is still exhibited under the high voltage.

Also, the result of the first experiment shown in FIG. 3 is also depicted in curved line S2 in FIG. 7. From the comparison between curved lines S1 and S2, when wafer W1 is disposed in the atmosphere in which ionizers 5 are arranged vertically above wafer W1 to supply ion directly to the below, a remarkable preventive effect against adhesion of the particles can be obtained.

Based on the above-described knowledge, exemplary embodiments of the atmosphere cleaning device of the present invention which effectively reduces the particles on the wafer W will be explained.

### First Embodiment

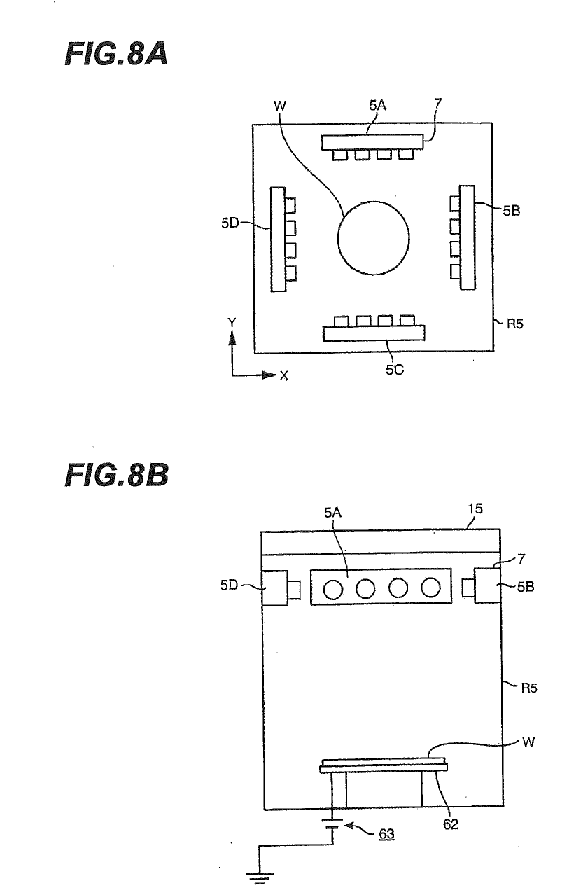

As shown in FIGS. 8a and 8b, an atmosphere cleaning device of a first embodiment is configured in which four groups 5A to 5D of ionizers 5 are arranged in the upper portion of the atmosphere where the wafer W is disposed. The four groups 5A to 5D are arranged at a same interval along the circumferential direction of the wafer W in a layout viewed from the top, wherein each of four groups 5A to 5D is constituted by four ionizers 5 arranged into a row. That is, two groups 5A and 5C of ionizers 5 face each other in the Y-direction of the figure, and two groups 5B and 5D of ionizers 5 face each other in the X-direction of the figure. In this example, two groups 5A and 5C form a group, and two opposing groups 5B and 5D form another group, thereby providing two groups. Reference numeral 7 denotes a support unit for supporting ionizers 5.

In this exemplary embodiment, the ions are supplied in a transverse direction, for example, a horizontal direction. This direction can be tilted downwardly, which is still the case where one ionizer 5 faces another ionizer 5. In addition, R5 represents a frame, for example, which can be a casing for defining an atmosphere in which wafer W is disposed, or a virtual line for defining a portion of the area in a large casing. That is, ionizers 5 are not limited to those installed on a wall of a casing.

Each of ionizers 5 has the same number of electrodes for generating the positive electric charge and the negative electric charge to generate equal amount of positive electric charge and negative electric charge, thereby permitting the ions having the same polarity as that of a charged body to repel the charged body and permitting the ions having a reverse polarity to be attracted to the charged body. As a result, the electric charge is neutralized and removed. Such ionizers 5 supply the ions by Coulomb's law which states that ions of the same polarity repel each other and ions of the opposite polarity attract each other.

And, in this embodiment, ionizers 5 should supply only positive or negative charged ions, and therefore, a high voltage is applied to just one of positive charge generating electrode and negative charge generating electrode to generate ion with only positive electric charge or only negative electric charge. Ionizers 5 supply ion with only positive or only negative electric charge to the down-flow by using the repulsive force between ions with the same polarity.

Referring to FIG. 8b, reference numeral 62 denotes, for example, a susceptor formed of conductors. Positive voltage of 0.5 kV for example is applied to susceptor 62 by a DC power source 63. Accordingly, the positive voltage is applied to the wafer W through susceptor 62. When this embodiment is actually applied to a semiconductor fabrication line, susceptor 62 is used as a transfer unit installed at the intermediate position between a first wafer transfer mechanism and a second wafer transfer mechanism in an atmospheric transfer process. Alternatively, the wafer W shown in FIG. 8a and FIG. 8b can be held by a holding unit of a wafer transfer mechanism instead of the susceptor. In this case, the wafer W can be located at the position in the wafer transfer mechanism that has the highest probability of holding the wafer W over the longest time. For example, the wafer W can be located at the position facing one of the processing units of a resist film deposition device. Also, referring to FIG. 8b, reference numeral 15 denotes an FFU. In addition, an exhaust fan which is not shown is installed upwardly on the bottom of the atmosphere in which the wafer W is disposed, such that the exhaust fan sucks the down-flow generated by the FFU 15, and discharges the down-flow to the outside, or delivers the down-flow to a circulation duct arranged in a clean room.

The atmosphere cleaning device is configured such that the down-flow is supplied to the wafer W from the FFU 15, voltages to be applied to electrodes of ionizers 5 arranged between the FFU 15 and the wafer W are set to the same size, and the ions are supplied from ionizers 5 to the down-flow thereby charging the particles existing in the peripheral atmosphere of the wafer W with a positive polarity. Further, by applying the positive voltage to the wafer W, electrostatic repulsive force acts on the particles charged with a positive polarity.

Here, an electric field is generated at the surface of the wafer W by the high voltage supplied to ionizers 5. In a plane view, ionizers 5 face each other in both the X-direction and the Y-direction with the wafer W interposed between ionizers 5, and therefore, an electric potential gradient generated around the surface of wafer W by an ionizer 5 is evened by the electric potential gradient generated by another ionizer 5 facing the ionizer 5. As a consequence, the electric potential near the surface of the wafer W by the electric line of force of ionizer 5 fluctuates less in the surface. Accordingly, the degree that the actual electric potential of the wafer W fits into a suitable range that prevents the adhesion of the particles becomes large when voltage to be applied to the wafer W is set. This enables the electrostatic repulsive force to act between the most of the particles and the wafer W, thereby reducing the adhesion of the particles onto the wafer W even for tiny particles.

In addition, ionizers 5 of this embodiment supply the ions by Coulomb's law, and does not use an airflow in supplying the ions. Therefore, ionizers 5 have no influence on the down-flow formed by FFU 15. Therefore, it is preferable because it does not hamper the removal of the particles, which is a unique function of the down-flow.

Here, just two groups (5A and 5C) of ionizers 5 are employed (without using groups 5B and 5D), and the adhesion of the particles is checked by the experimental device shown in FIG. 2. The result is different from the result of the experiment shown in FIG. 5 which shows that half of the area of the wafer W is adhered with particles. That is to say, less amount of particles are adhered throughout the entire surface of the wafer W. Accordingly, it can be determined that the reduction effect of the particles in this exemplary embodiment is remarkably excellent over the case where ionizers 5 are arranged at one side as shown in FIG. 2.

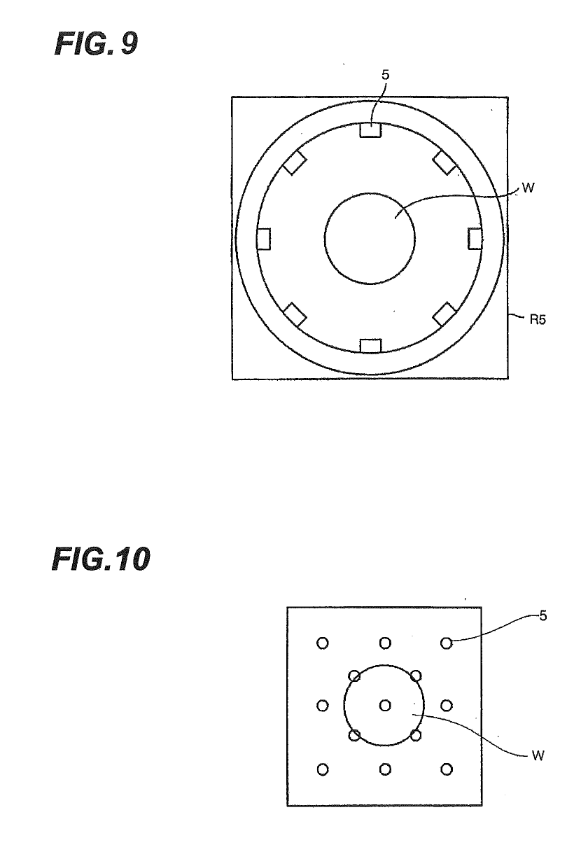

The atmosphere cleaning device shown in FIG. 9 is a modified example of the first embodiment. The atmosphere cleaning device shown in FIG. 9 is configured such that a plurality of ionizers 5, say, eight ionizers 5, are arranged in the upper portion of the atmosphere where the wafer W is disposed, that is, in the upper portion of the device. The eight ionizers 5 are arranged at the same interval along the circumferential direction, along the concentric circle with the wafer W. Here, opposing ionizers 5 face each other, and the distances from the center of the wafer W to each of ionizers 5 are identical. Each of ionizers 5 is set to supply the ions in a horizontal direction. In such a configuration, electric potential gradient generated around the surface of the wafer W by an ionizer 5 is evened by the electric potential gradient generated by another ionizer 5 facing the ionizer. Thus, the modified example of the first embodiment may achieve the same effects as that of the first embodiment.

### Second Embodiment

FIG. 10 illustrates an atmosphere cleaning device according to a second embodiment. In this embodiment, ionizers 5 are arranged above the region where the wafer W is disposed, and in the peripheral region. That is, ionizers 5 are arranged above the region where the wafer W is disposed, and above the peripheral region of the device. In detail, a plurality of ionizers 5 (13 ionizers in FIG. 10) are arranged into a zigzag shape in the upper portion of the device. Each of ionizers 5 supplies ion downwardly, for example, to the direct below. Such layout of ionizers 5 is particularly suitable in the transfer atmosphere (atmosphere above a transfer path) in which the wafer W is transferred. Here, the transfer atmosphere may refer to an interior of a chamber, for example. The transfer atmosphere can be a transfer region for transferring the wafer W among each of the process units (such as a unit for depositing an application liquid, or a heating unit) to form an application film such as a resist film or an insulation film on the wafer W.

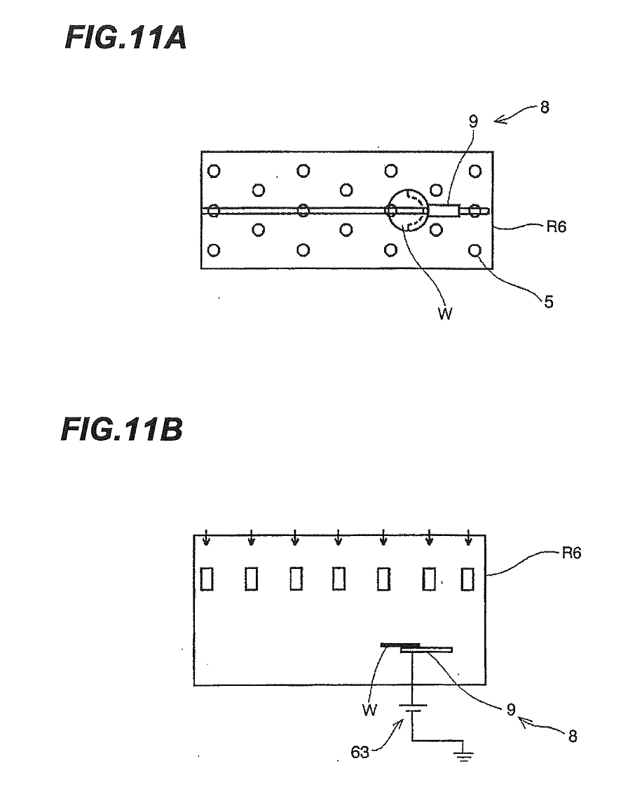

FIG. 11A and FIG. 11B illustrate a modified example of the second embodiment. Referring to FIG. 11A and FIG. 11B, the line represented by R6 is a wall of a chamber or a virtual line in a transfer region. While reference numeral 8 denotes a transfer device for transferring the wafer W, FIG. 11A and FIG. 11B show the portion of a holding arm 9 for holding the wafer W for convenience' sake. The wafer W is fed with a positive voltage through transfer device 8 from DC power source 63. Transfer device 8 is arranged to be movable in forward and backward directions, rotatable about a vertical axis, and movable in upward and downward directions. In this embodiment, a plurality of ionizers 5 (eighteen ionizers in FIG. 11) are arranged into a zigzag shape in the region above the wafer transfer region and in the peripheral region, that is, above the region where the wafer W is transferred by a wafer transfer device 8 and above the peripheral region of the device.

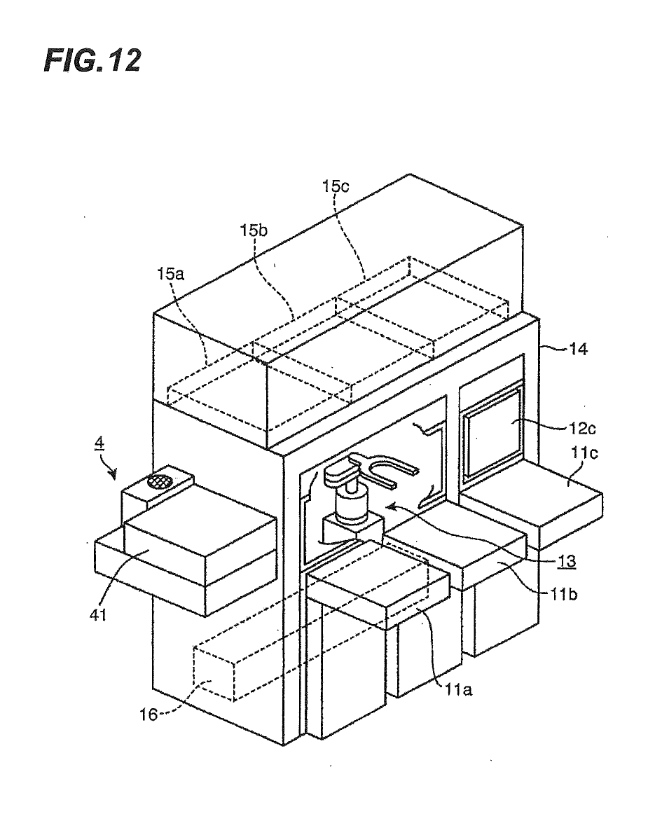

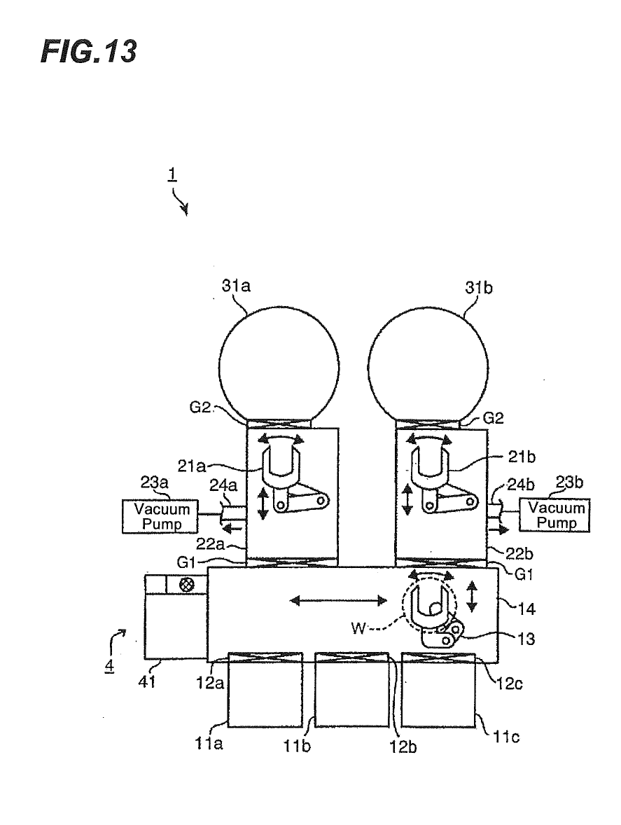

Detailed example of the second embodiment will be described hereinafter. FIG. 12 and FIG. 13 illustrate a device which is called a multi-chamber. This device includes an atmospheric transfer chamber 14, a first transfer device 13 installed in atmospheric transfer chamber 14, FOUP (Front-Opening Unified Pod) load boards 11a to 11c arranged at the front side of atmospheric transfer chamber 14 to load FOUP which are closed type wafer carriers thereon, and carry-in/carry-out doors 12a to 12c installed at a side wall of atmospheric transfer chamber 14 such that doors 12a to 12c correspond to FOUP load boards 11a to 11c, respectively. In addition, atmospheric transfer chamber 14 is equipped with an orienter 4 accommodated in an orienter receptacle 41, wherein orienter 4 serves as a functional module for determining the direction and location of the wafer W carried into the multi-chamber.

In addition, FFUs 15a to 15c are installed in the upper portion of atmospheric transfer chamber 14 to constitute a first airflow forming means. Each of FFUs 15a to 15c includes a fan unit in which a fan with a rotary blade and a motor are accommodated in a casing, and a filter unit arranged at the discharge side of the fan unit and equipped with an ultra low penetration air (ULPA) filter, for example.

Further, an exhaust FFU 16 is installed in the lower portion of atmospheric transfer chamber 14 to constitute a second airflow forming means, in such a manner that exhaust FFU 16 faces FFUs 15a to 15c. Exhaust FFU 16 is configured similarly to FFUs 15a to 15c, except that a chemical filter unit is installed in exhaust FFU 16 to remove acid gases in accordance with the change in the ULPA filter.

The first airflow forming means and the second airflow forming means cooperate with each other to form a down-flow of the clean air in atmospheric transfer chamber 14. Because of this, the inside of atmospheric transfer chamber 14 is formed with a mini-environment constituted by the clean air.

Also, as shown in FIG. 13, atmospheric transfer chamber 14 has two gates G1 installed at the wall thereof that faces the carry-in/carry-out doors 12a to 12c. Load-lock chambers 22a and 22b equipped with respective second transfer devices 21a and 21b therein are connected through gates G1. Process containers 31a and 31b are connected to the respective load-lock chambers 22a and 22b through gates G2, and vacuum pumps 23a and 23b are connected to the respective load-lock chambers 22a and 22b through respective exhaust pipes 24a and 24b. With such configuration, pressure in load-lock chambers 22a and 22b can be switched between a predetermined vacuum atmosphere and an atmospheric pressure, at the state where gates G1 and G2 are closed.

In the multi-chamber device, the wafer W is extracted by first transfer device 13 from the FOUP disposed on the respective FOUP load boards 11a to 11c, and carried into orienter 4 to determine the direction and the location of the wafer W. Subsequently, the wafer W is carried-out from orienter 4 by first transfer device 13, and delivered to either one of second transfer devices 21a or 21b through the open gate G1. The load-lock chambers 22a or 22b where the wafer W is delivered has an interior in which the pressure is reduced to switch to a predetermined vacuum atmosphere if needed, after closing gate G1. Subsequently, gate G2 is opened to allow the wafer W to be carried into process containers 31a or 31b. Then, processes such as an etching process are conducted in process containers 31a or 31b.

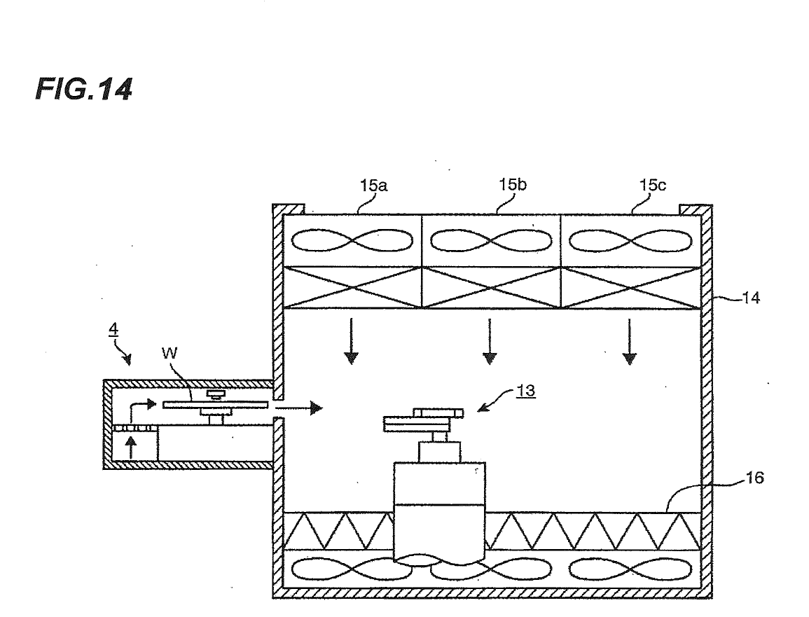

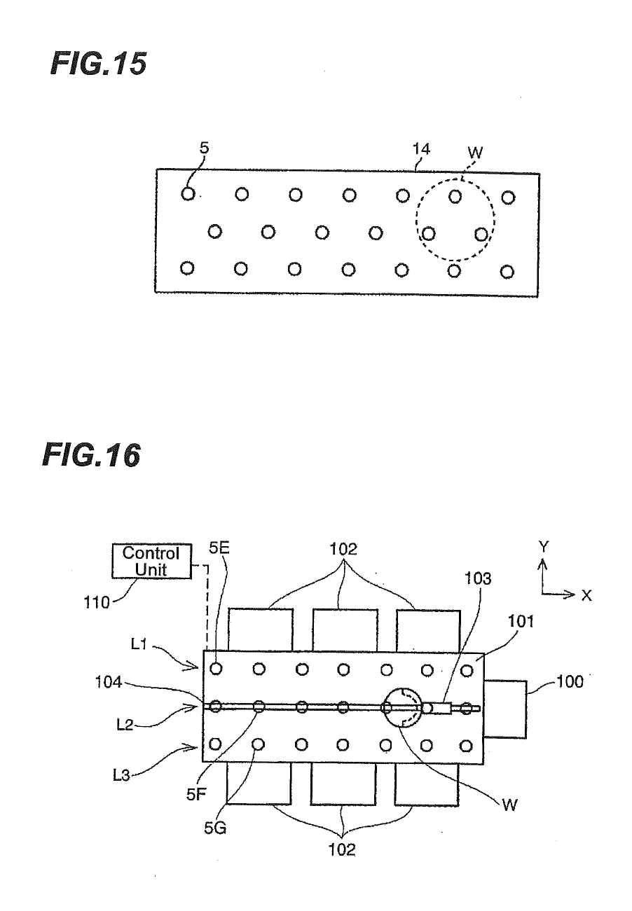

In the multi-chamber, as shown in FIG. 14 and FIG. 15, a plurality of ionizers 5 are arranged below FFUs 15a to 15c of atmospheric transfer chamber 14, similarly to the arrangement shown in FIG. 11A and FIG. 11B. Thus-configured multi-chamber enables the down-flow of the clean air in the atmospheric transfer chamber 14 to be ionized by ionizers 5. In addition, first transfer device 13 is equipped with voltage applying means (not shown) for applying the voltage having the same polarity as that of the down-flow to the wafer W, thereby applying the voltage to the wafer W being transferred.

As described above, in a case where ionizers 5 are arranged with a grid shape (a layout where ionizers 5 are placed at the crossing points) or a zigzag shape, ionizers 5 can be arranged with a less bias when ionizers 5 are viewed from the wafer side even though the wafer W is located anywhere. Thus, the electric potential gradient generated around the surface of the wafer W by an ionizer 5 is evened by the electric potential gradient generated by another ionizer 5. As a result, a uniform suppression effect of the adhesion of the particles to the wafer W is obtained throughout the surface. From the result of the second experiment shown in FIG. 7, it has been confirmed that a remarkable effect of reducing the particle adhesion is exhibited when three ionizers 5 are arranged into a row directly above the wafer W. However, the configuration of the second embodiment gives even a superior effect of reducing the particle adhesion.

This embodiment has a configuration such that the region above the wafer W containing the region above the peripheral region of the device is divided into a plurality of quadrangles (squares, rectangles, or parallelograms), and ionizers 5 are disposed at each of crossing points of the quadrangles, or disposed in a zigzag shape. Further, this embodiment can be modified into a configuration such that ionizers 5 are arranged in two rows, and a transfer path is formed between the two rows (center) along the lengthwise direction of the rows in a plane layout. For example, the center row among the three rows of ionizers 5 shown in FIG. 15 can be deleted, and a transfer path can be formed along the trace of the center row. In this case, ionizers 5 in one row and ionizers 5 in another row face each other through the transfer path formed therebetween.

The arrangement of ionizers 5 is not limited by those enumerated above. From the result of the second experiment shown in FIG. 7, it can be expected that the arrangement in which ionizers 5 are spaced apart from each other in a transverse direction, above the wafer region, reduces the adhesion of the particles to the wafer W. In this case, when the atmosphere in which the wafer W is disposed is a wafer transfer region, it is preferable that the plurality of ionizers 5 are arranged into a row or a zigzag shape, for example, along the wafer transfer direction. In this case, it is more preferably that ionizers 5 are arranged directly above the wafer transfer path (that is, the wafer transfer path and ionizers 5 are superimposed each other from a top view). As to a layout of ionizers 5, it is preferable that at least one ionizer is arranged directly above wafer W when the wafer W is located anywhere on the wafer transfer path.

### Third Embodiment

Also, in the present invention, voltage to be applied to electrodes of ionizers 5 can be controlled in accordance with the location of the wafer W. Exemplary embodiment for this will be described hereinafter.

FIG. 16 illustrates a liquid process system according to the third embodiment of the present invention. This embodiment has a basic configuration of a liquid process system in which an insulation film or a resist film is formed by the application of an application liquid. Reference numeral 100 denotes a wafer carry-in/carry-out port equipped with a delivery board. Reference numeral 101 denotes an atmospheric transfer region which has both sides along which a plurality of process units 102 are arranged. A transfer device 103 is installed in atmospheric transfer region 101 such that transfer device 103 is movable along a guide 104. Transfer device 103 is constituted by a joint arm which is movable in forward and backward directions, and rotatable about a vertical axis. Wafers W delivered to wafer carry-in/carry-out port 100 from an external source are sequentially transferred to process units 102 by transfer device 103. The process units 102 correspond to an application unit for applying a liquid onto the wafer W, a drying unit for vacuum drying the wafer W after the application, and a baking unit for baking the wafer W after the vacuum drying.

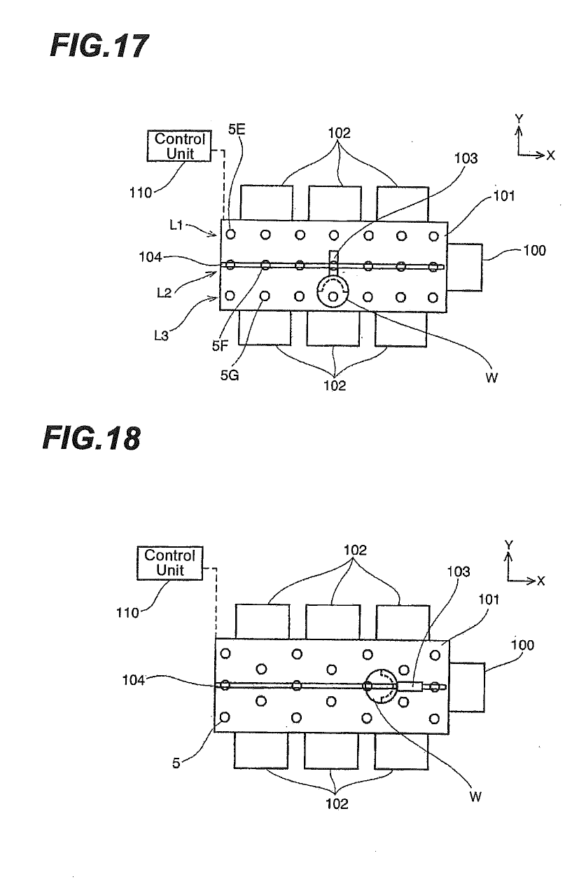

In such a liquid process system, the wafer transfer sequence for transferring the wafers W to the process units is predetermined. According to the process status of the process unit 102, the wafer W may be on standby in front of a process unit102, as shown in FIG. 17. Ionizers 5 arranged into a row along the X-direction are symmetrically arranged with respect to guide 104, for example, arranged into three rows of L1, L2, and L3, as shown in FIG. 17. As aforementioned, when the wafer W is on standby on the transfer device, ionizer 5G on the third row L3 is closer to the center of the wafer W than ionizer 5F on the second row L2.

In this case, when the same voltage is applied to ionizer 5F and to ionizer 5G, electric potential in the region of ionizer 5G rises based on the electric line of force from ionizer 5G, and then particles are attracted to the wafer W in the ionizer 5G side, as known in the result of the second experiment described above. In order to prevent this, in a case where the wafer W is on standby, the voltage to be applied to ionizer 5G which has the wafer standby location as an ion supply range needs to be controller to be smaller than the voltage applied to ionizer 5F by a control unit 110.

Meanwhile, as shown in FIG. 16, ionizer 5F on the second row L2 gets closer to the center of the wafer W when the wafer W is being transferred along guide 104. Here, ionizers 5E and 5G on the respective first row L1 and the third row L3 are equally spaced apart from the circumferential edge of the wafer W. Here, in order to prevent the electric potential of the wafer W from locally rising based on the electric line of force from ionizer 5F, the voltage to be applied to ionizer 5F on the second row L2 needs to be controlled by control unit 110 such that the voltage becomes smaller than the voltage to ionizers 5E and 5G on the respective first row L1 and third row L3. The voltage after the control may be determined by the ratio between the center of the wafer W and the distances of ionizers disposed on each of rows L1, L2, and L3.

FIG. 18 illustrates a modified example of the third embodiment in which a plurality of ionizers 5 (eighteen ionizers in FIG. 18) are arranged into a zigzag shape in the entire region above the wafer transfer region, that is, the entire region where the wafer W is transferred along guide 104 and the region above the peripheral region of the device. Such arrangement enables the wafer W to be transferred always within the ion supply range of ionizer 5, and enables charged down-flow to be constantly supplied. In the modified example of the third embodiment, as ionizers 5 are arranged into a grid shape or a zigzag shape, electric potential gradient generated around the surface of the wafer W by one ionizer 5 is evened by the electric potential gradient generated by adjacent another ionizer 5. As a result, the modified example of the third embodiment achieves the same effects as those of the atmosphere cleaning device of the second embodiment.

In a case where ionizers 5 are arranged above the wafer transfer region, the arrangement of ionizers are not limited to those in which ionizers 5 are arranged at each top of quadrangles or arranged into a zigzag shape where the quadrangles are obtained by dividing the upper surface of the main body of the device into a plurality of quadrangles based on the coordinates of the orthogonal coordinate system corresponding to each side of the upper surface of the main body of the device. For example, it is also possible to determine the location of the ionizers based on the coordinate system which obliquely intersect each side of the upper surface of the main body of the device.

The present invention can be applied to any type of devices which clean the atmosphere of the work environment. The present invention may not be limited to a semiconductor fabrication line, and therefore, can be applied to, for example, a medicine production line of producing pellet type medicines.

1. An atmosphere cleaning device characterized by comprising:
means for forming a down-flow in an atmosphere where a treating object is located;
a plurality of ionizers arranged over the treating object symmetrically with each other with the treating object therebetween in layout viewed from a top, so as to supply either cation or anion to the down-flow in a transverse direction; and
means for applying DC voltage having a polarity same as that of the voltage applied to electrodes of the plurality of ionizers to the treating object,
wherein the symmetrically arranged ionizers are arranged to face each other.

2. The atmosphere cleaning device of claim 1, wherein the symmetrically arranged ionizers are formed into a plurality of groups along a periphery of the treating object.

3. The atmosphere cleaning device of claim 1, wherein the plurality of ionizers arranged along the periphery of the treating object are grouped, and the groups are symmetrically arranged interposing the treating object therebetween in a layout viewed from a top.

4. The atmosphere cleaning device of claim 3, wherein the groups are those in which a plurality of ionizers are arranged in a transverse row.

5. The atmosphere cleaning device of claim 1, further comprising a band type transfer path for transferring the treating object, and wherein, the transfer path has both sides along which a plurality of ionizers are arranged in a row in a plane layout.

6. An atmosphere cleaning device characterized by comprising:
means for forming a down-flow in an atmosphere where a treating object is located;
a plurality of ionizers spaced apart from each other in a transverse direction over the treating object so as to supply either cation or anion downwardly to the down-flow; and
means for applying DC voltage having a polarity same as that of the voltage applied to electrodes of the plurality of ionizers to the treating object.

7. The atmosphere cleaning device of claim 6, wherein the atmosphere where the treating object is located is an atmosphere where the treating object is transferred by a transfer device, and the plurality of ionizers are arranged along with an object transfer direction.

8. The atmosphere cleaning device of claim 7, wherein the plurality of ionizers are disposed directly above the object transfer path.

9. The atmosphere cleaning device of claim 6, wherein the atmosphere where the treating object is located is an atmosphere where the treating object is transferred by a transfer device, and the plurality of ionizers are arranged at locations corresponding to respective tops of quadrangles when a region is divided into a plurality of quadrangles of the same size in a layout viewed from a top.

10. The atmosphere cleaning device of claim 6, wherein the atmosphere where the treating object is located is an atmosphere where the treating object is transferred by a transfer device, and the plurality of ionizers are arranged into a zigzag shape in a layout viewed from a top.

11. The atmosphere cleaning device of claim 9, wherein the plurality of ionizers has a layout in which a row of ionizers are arranged in any one of X-direction and Y-direction orthogonal to each other on a horizontal plane, or three or more rows of ionizers are arranged.

12. An atmosphere cleaning device characterized by comprising:
means for forming a down-flow in an atmosphere where a treating object is transferred by a transfer device;
a plurality of ionizers arranged above an object transfer region in a layout viewed from a top so as to supply either cation or anion to the down-flow;
means for applying DC voltage having a polarity same as that of the voltage applied to electrodes of the plurality of ionizers to the treating object; and
means for controlling the size of the voltage applied to the electrodes of the ionizers in accordance with the location of the treating object.

13. The atmosphere cleaning device of claim 2, wherein the plurality of ionizers arranged along the periphery of the treating object are grouped, and the groups are symmetrically arranged interposing the treating object therebetween in a layout viewed from a top.

14. The atmosphere cleaning device of claim 10, wherein the plurality of ionizers has a layout in which a row of ionizers are arranged in any one of X-direction and Y-direction orthogonal to each other on a horizontal plane, or three or more rows of ionizers are arranged.
